(19) United States
(12) Patent Application Publication
(10) Pub. No.: US 2009/0315719 A1
(43) Pub. Date: Dec. 24, 2009

(54) FALL ACCIDENT DETECTION APPARATUS AND METHOD

(76) Inventors: Sa Kwang SONG, Daejeon (KR); Jae Won JANG, Daejeon (KR); Soo Jun PARK, Seoul (KR); Seon Hee PARK, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/356,199

(22) Filed: Jan. 20, 2009

(30) Foreign Application Priority Data
Jun. 24, 2008 (KR) 10-2008-0059764

(51) Int. Cl. G08B 23/00; G08B 21/00

(52) U.S. Cl. 340/573.1; 340/669

(57) ABSTRACT

Provided are a fall accident detection apparatus and method capable of detecting frequent falling accidents in daily lives of old, feeble or invalid pedestrians in real time and notifying a fall control server of the falling accidents in order to actively prepare for possible secondary accidents by falls. The fall accident detection apparatus includes an acceleration sensor detecting information on acceleration and slope; a controller judging behaviors using the information on acceleration and slope detected by the acceleration sensor and determining a fall accident by analyzing a sequential pattern of the judged behaviors; and a communication unit transmitting information on a fall accident when the fall accident is determined by the controller.

### CROSS-REFERENCE TO RELATED APPLICATIONS

This application claims the priority of Korean Patent Application No. 2008-59764 filed on Jun. 24, 2008, in the Korean Intellectual Property Office, the disclosure of which is incorporated herein by reference.

### BACKGROUND OF THE INVENTION

1. Field of the Invention

The present invention relates to a fall accident detection apparatus and method, and more particularly, to a fall accident detection apparatus and method capable of detecting frequent falling accidents in daily lives of old, feeble or invalid pedestrians in real time and notifying a fall control server of the falling accidents in order to actively prepare for possible secondary accidents by falls.

2. Description of the Related Art

With the rapid progress of an aging society, a variety of healthcare services have been provided to help old, feeble or invalid pedestrians enjoy their daily lives safely.

As the elderly population that generally live alone have suffered from falling accidents far more frequently than active young persons, a variety of healthcare services that are helpful to the elderly in preparing for falls have come into the spotlight, and therefore ardent attempts to develop the healthcare services are also under way.

However, conventional post-fall rescue methods have problems in that the battery consumption is very high, the errors in fall accident detections are increased, and a filtering effect on error detection is poor since data is transmitted in a wireless mode and a sensor is separated from a mobile phone. Furthermore, conventional post-fall rescue methods have difficulties with the sensor that may judge, as the falls, user's normal behaviors (i.e. behaviors where a user puts the sensor on/off, waves his hand, runs and strikes into something) having a sensor value similar to the falls since the sensor is highly dependent on instantaneous data changes used to detect a fall.

### SUMMARY OF THE INVENTION

An aspect of the present invention provides a fall accident detection apparatus and method capable of exactly distinguishing a fall from its similar behaviors not by judging a fall accident in real time using recent measured data, but by judging not only measured data that are likely to be a fall but also post-fall behaviors at the same time in order to precisely determine a fall accident.

Another aspect of the present invention provides a fall accident detection apparatus and method capable of preventing secondary damages, which may be caused by falls, by notifying guardians, emergency call centers or the like of the falls that are detected by a communication system.

According to an aspect of the present invention, there is provided a fall accident detection apparatus including an acceleration sensor detecting information on acceleration and slope; a controller judging behaviors using the information on acceleration and slope detected by the acceleration sensor and determining a fall accident by analyzing a sequential pattern of the judged behaviors; and a communication unit transmitting information on a fall accident when the fall accident is determined by the controller.

In this case, the controller may store the information on acceleration and slope, which is detected by the acceleration sensor, into a data queue. And the controller may take some data from the data queue at predetermined intervals, judge behaviors using the data and stores the judged behaviors in a behavior queue. Also, the controller may take a certain number of behavior values out of the behavior queue at predetermined intervals and determines a fall accident by comparing the behavior values with a predetermined pattern of behavior queues.

Also, the acceleration sensor may be a 3-axis acceleration sensor.

In addition, the fall accident detection apparatus according to one exemplary embodiment of the present invention may further include a GPS unit detecting information on current location, wherein the controller transmits the information on current location along with the information on the fall accident through the communication unit.

Furthermore, the fall accident detection apparatus according to one exemplary embodiment of the present invention may further include an output unit outputting a fall confirmation signal when the fall accident is determined by the controller; and a button unit inputting a signal indicating that there is no fall accident from a user. In this case, the button unit may further include function for inputting a signal indicating that the user is under a medical emergency.

According to an aspect of the present invention, there is provided a fall accident detection method including: detecting information on acceleration and slope; judging behaviors using the detected information on acceleration and slope; determining a fall accident by analyzing a sequential pattern of the judged behaviors; and transmitting information on the fall accident based on the determination of the fall accident.

In this case, the fall accident detection method according to one exemplary embodiment of the present invention may further include: detecting information on current location.

Also, the judging of the certain behaviors may include: storing the information on acceleration and slope into a data queue; taking a certain number of data from the data queue at predetermined intervals; judging behaviors using the taken data; and storing the judged behaviors in a behavior queue.

In addition, the determining of the fall accident may include: taking a certain number of behavior values out of the behavior queue at predetermined intervals; and determining a fall accident by comparing the behavior values with a predetermined pattern of behavior queues.

Furthermore, the fall accident detection method according to one exemplary embodiment of the present invention may further include: outputting an alarm signal activated by the determination of the fall accident, and canceling the determination of the fall accident when a user presses a button in response to the alarm signal activated by the determination of the fall accident.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a conceptual view illustrating a fall-detection system according to one exemplary embodiment of the present invention.

FIG. 2 is a diagram illustrating a configuration of a fall accident detection apparatus according to one exemplary embodiment of the present invention.

FIG. 3 is a diagram illustrating data of a 3-axis acceleration sensor according to one exemplary embodiment of the present invention.

FIG. 4 is a diagram illustrating the results obtained by subjecting the data of FIG. 3 into a low pass filter (LPF).

FIG. 5 is a diagram illustrating the results obtained by subjecting the data of FIG. 3 into a high pass filter (HPF).

FIG. 6 is a diagram illustrating a fall accident detection method according to one exemplary embodiment of the present invention.

FIG. 7 is a diagram illustrating a configuration of a fall control server according to one exemplary embodiment of the present invention.

FIG. 8 is a flowchart illustrating an operation of the fall control server according to one exemplary embodiment of the present invention.

### DETAILED DESCRIPTION OF THE PREFERRED EMBODIMENT

Exemplary embodiments of the present invention will now be described in detail with reference to the accompanying drawings. For the exemplary embodiments of the present invention, detailed descriptions of known functions and constructions that are related to the present invention are omitted for clarity when they are proven to make the gist of the present invention unnecessarily confusing.

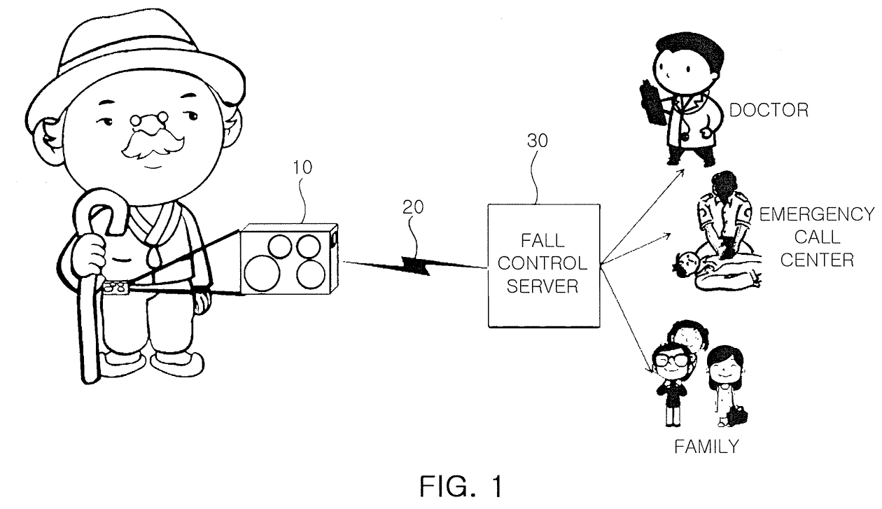

FIG. 1 is a conceptual view illustrating a fall accident detection system according to one exemplary embodiment of the present invention.

Referring to FIG. 1, the fall accident detection system includes a fall accident detection apparatus 10 and a fall control server 30 connected to the fall accident detection apparatus 10 through a wireless communication system 20. In order to preventing secondary damages that may be caused by the fall, the fall accident detection apparatus 10 detects a fall by being mounted to a user, and the fall control server 30 receives information on the fall accident transmitted from the fall accident detection apparatus 10 and notifies a doctor, an emergency call center or his family of user's medical emergency.

For example, FIG. 1 shows that the fall accident detection apparatus 10 for detecting a user's fall is installed on the waist of a user. The fall accident detection apparatus 10 determines a fall accident using information on acceleration, slope and current location corresponding to a user's moving, and notifies the fall to the fall control server 30 through the wireless communication system 20 when the information is judged to be a fall. When the fall control server 30 receives the information on the fall accident, the fall accident detection apparatus 10 notifies predetermined contact point of the information on the fall. In this case, the predetermined contact point may be his family's contact numbers, hospitals and doctors, emergency call centers, etc.

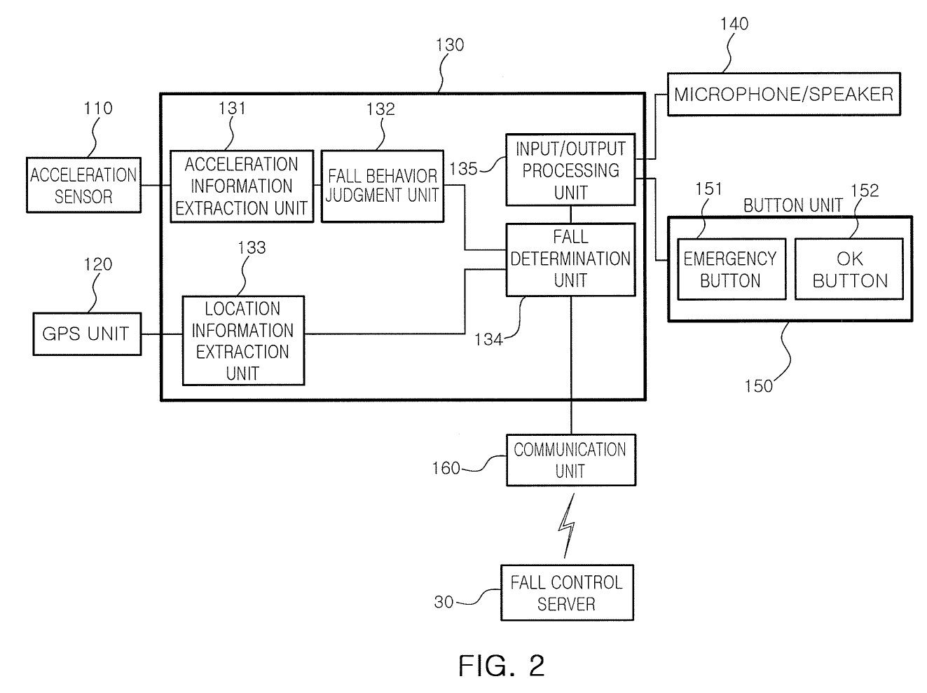

FIG. 2 is a diagram illustrating a configuration of a fall accident detection apparatus according to one exemplary embodiment of the present invention.

The fall accident detection apparatus 10 according to one exemplary embodiment of the present invention includes an acceleration sensor 110, a GPS unit 120, a controller 130, an input/output device such as a microphone/speaker 140, a button unit 150 and a communication unit 160. The components of the fall accident detection apparatus 10 is described in more detail, as follows.

The acceleration sensor 110 may include a variety of acceleration sensors that may detect information on acceleration and slope. A 3-axis acceleration sensor maybe used in one exemplary embodiment of the present invention. The 3-axis acceleration sensor senses information on 3-axis acceleration and slope when a user moves around.

The GPS unit 120 detects information on a current location of the fall accident detection apparatus 10. The information on the current location detected by the GPS unit 120 is transmitted along with the information on the fall accident to a user's family through the fall control server 30 coupled to the communication unit 160 when user's behaviors are judged as a fall behaviors.

The controller 130 judges user's fall behaviors using the information on acceleration and slope that is detected from the acceleration sensor 110, confirms the fall accident from a user using a speaker 140, transmits the user's fall to the fall control server 30 through the communication unit 160, and finally transmits a message about a medical emergency of falls to a user's family, a doctor, an emergency call center, etc.

The controller 130 includes an acceleration information extraction unit 131, a fall behavior judgment unit 132, a location information extraction unit 133, a fall determination unit 134 and an input/output processing unit 135.

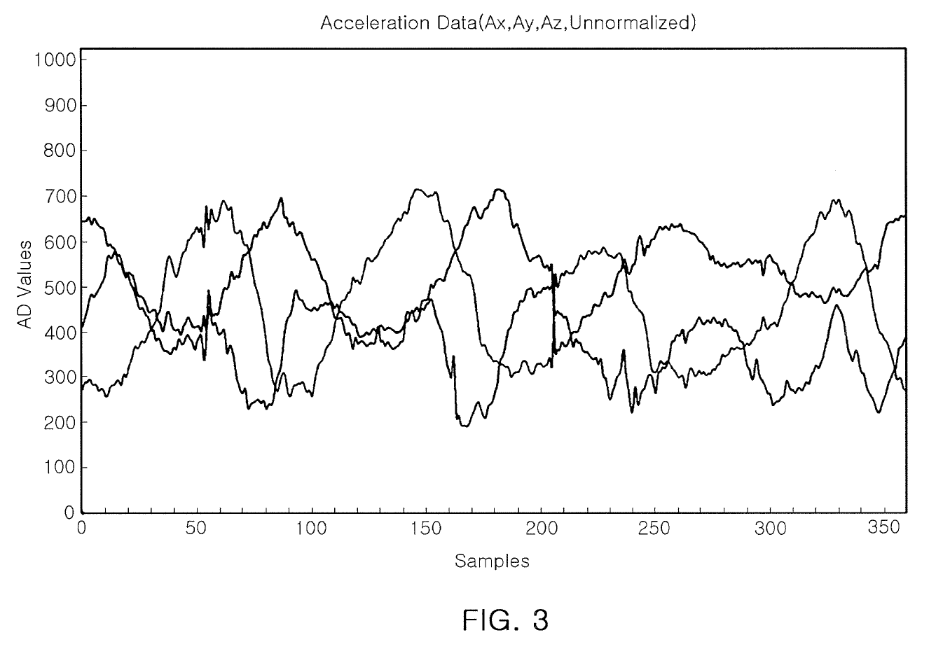

The acceleration information extraction unit 131 extracts user's information on acceleration and slope detected by the acceleration sensor 110 such as a 3-axis acceleration sensor. In general, the 3-axis acceleration sensor measures a signal (raw data) as shown in FIG. 3. Here, the measured signal includes a motion acceleration component such as an acceleration/deceleration of walking or movement and a gravity acceleration component such as a slope.

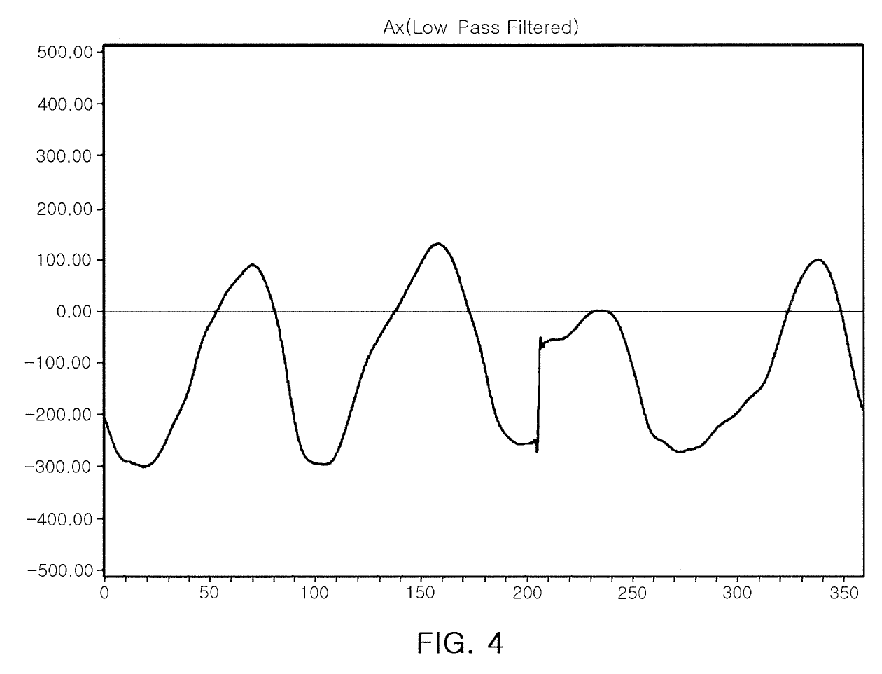

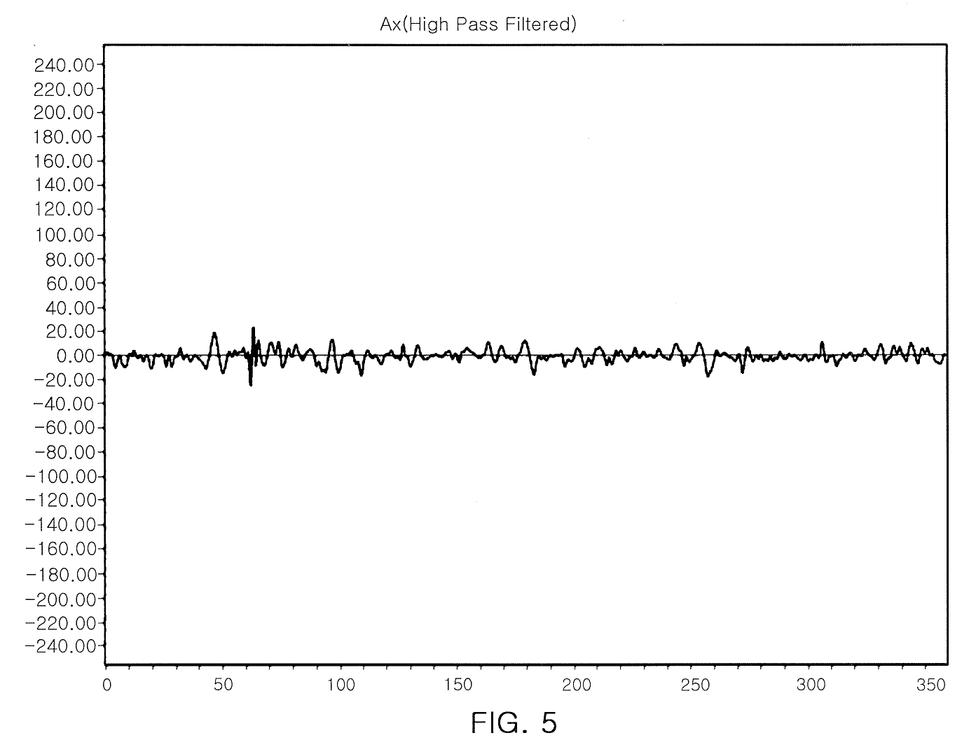

In this case, the motion acceleration component is arranged in a high-frequency band at a frequency domain, and the gravity acceleration component is arranged in a low-frequency band at the frequency domain, and therefore the acceleration information extraction unit 131 extracts motion acceleration values (Ax, Ay and Az) using a high pass filter (HPF), and extracts gravity acceleration values (Tx, Ty and Tz) using a low pass filter (LPF). For example, FIG. 4 shows a signal obtained by extracting a gravity acceleration component from the data of FIG. 3 using a low pass filter (LPF), and FIG. 5 shows a signal obtained by extracting a motion acceleration component from the data of FIG. 3 using a high pass filter (HPF).

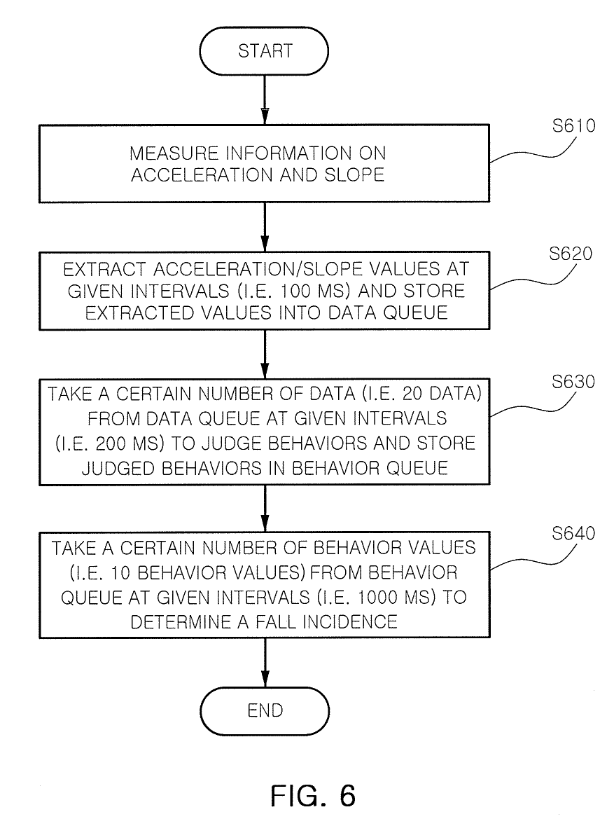

The fall behavior judgment unit 132 judges a fall accident at constant intervals using the information on acceleration and slope extracted from the acceleration information extraction unit 131. The judgment of fall behaviors by the fall behavior judgment unit 132 is performed using a fall accident detection algorithm as shown in FIG. 6.

First, the acceleration sensor 110 continuously measures user's information on acceleration and slope (S610).

When the acceleration sensor 110 detects the acceleration and the slope, the acceleration information extraction unit 131 extracts information on the acceleration and the slope at given intervals (for example, 100 milliseconds (ms)) and stores the extracted information into a data queue (not shown). Here, the information on acceleration is extracted in the form of a motion acceleration component and gravity acceleration component, and the extracted motion and gravity acceleration components are stored in the data queue (S620).

The fall behavior judgment unit 132 takes a certain number of data (for example, 20 data) from the data queue at predetermined intervals (for example, 200 ms), judges behaviors using the taken data, and stores the judged behaviors into a behavior queue (not shown) (S630). More particularly, the fall behavior judgment unit 132 analyzes the data taken from the data queue, and judges behaviors corresponding to the analyzed data.

In this case, the behavior judgment is performed using the 20 data stored in the data queue. Here, slope and acceleration values corresponding to x, y and z axes of the 20 data, the excess or deficit of given critical values of the slope and acceleration values, a variation in time between prior and post slope and acceleration values corresponding to the x, y and z axes of the 20 data, the excess or deficit of critical values of the variation in time are used to judge user's behaviors. In this case, the expression “variation in time” means a variation of prior and post slope/acceleration values in relation to current slope/acceleration values. For example, let assume that a current acceleration is 10, 3 prior accelerations are 1, 3 and 6, and 3 post accelerations are 4, 1 and 0. Here, the prior variation in time represents a weighted sum (2×A1+3×A2+4×A3) of the differences in acceleration (3−1=2, 6−3=3 and 10−6=4) of the prior acceleration values from the current acceleration value, and the post variation in time represents a weighted sum (6×B1+3×B2+1×B3) of the differences in acceleration (10−4=6, 4−1=3 and 1−0=1) of the current acceleration value from the respective acceleration values. The weighted values A and B in the weighted sum get smaller as the acceleration becomes more distant from the current acceleration, which indicates that the acceleration is in inverse proportion to the current acceleration, and the optimum acceleration value is allotted through repeated experiments. A determination model of judging behaviors using inputted data is configured using a decision tree method that is a widely used machine learning technology.

The information on the behavior judgment stored in the behavior queue by the fall behavior judgment unit 132 is information on temporary behaviors that are made at predetermined intervals (for example, 200 ms), but not information on the final judgment of a fall accident. These temporary behaviors include, for example, sitting, lying, walking, running, standing, standing-up, falling, etc.

The final judgment of the fall accident is performed by analyzing a sequential pattern of behaviors stored in a behavior queue (S640). For this purpose, the fall behavior judgment unit 132 takes a certain number of behavior values (for example, 10 behavior values) from the behavior queue at given intervals (for example, 1000 ms), and finally determines a fall accident by comparing the extracted behavior values with the predetermined pattern of behavior queues.

In order to improve the reliability of the judgment of the fall accident, this final judgment of the fall accident may be performed not by judging a fall accident in real time, but by suspending the judgment of the fall accident for a given period and judging the fall accident in consideration of the post-fall behaviors that are likely to be a fall in addition to the fall accident.

Examples of the predetermined behavior queue may be set to various queues such as (*, falling, ?, lying, lying), (*,falling, ?, ?, lying, lying), etc. Here, the symbol ‘*’ represents a pattern of random behaviors regardless of the number of behaviors, and the symbol ‘?’ represents a pattern of one random behavior.

For example, assume that there is a behavior queue of (walking, walking, falling, walking, walking). When a fall behaviors occurs but walking behaviors before/after the fall behaviors are detected, an abnormal fall behaviors appears due to an instantaneous error or impact during the walking behavior but the walking behavior keeps going. In this case, although the fall behaviors occurs, this fall behaviors is disregarded without being recognized as a fall. Also, assume that there is a behavior queue of (walking, falling, sitting, lying, lying). Since there is a ‘sitting’ behavior after a fall behaviors, and lying behaviors are sequential to the sitting behavior, this behavior proves to be a fall.

When a user's behavior is finally judged to be a fall by comparison of the behavior patterns by the fall behavior judgment unit 132, information on the fall accident is transmitted to the fall determination unit 134.

Also, the location information extraction unit 133 extracts information on current location of the fall accident detection apparatus 10 and its user from the GPS unit 120 at predetermined intervals (for example, 1 sec.), and stores the information in a memory (not shown).

The fall determination unit 134 generates an alarm signal associated with the fall accident through the speaker 140 coupled to the input/output processing unit 135 when a fall happens. The fall determination unit 134 determines that a user has fallen down when there is no signal from an OK button 152 of the button unit 150 for a certain time after the generation of the alarm, and transmits information on the user's fall accident to the fall control server 30 through the communication unit 160. Here, the transmitted information on the fall accident includes information on a user's location stored in a memory by the location information extraction unit 133.

However, when a user press the OK button 152 to transmit a signal, the fall determination unit 134 judges that the user is not harmed from a dangerous fall, and does not transmit information on the user's fall accident to the fall control server 30.

When the fall control server 30 receives the information on the user's fall accident from the fall accident detection apparatus 10, the fall control server 30 calls the user to verify the fall accident once more, and outputs a phone reception sound through the microphone/speaker 140. In this case, when a user presses the OK button 152, a signal of the phone reception sound is transmitted to the fall determination unit 134 through the input/output processing unit 135, and the fall determination unit 134 cancels a fall alarm according to the transmitted signal from the user's OK button, and simultaneously suspends all alarm and bell calls.

However, when a user does not press an OK button in response to a phone call from the fall control server 30, the fall determination unit 134 finally transmits a fall accident detection message about a user's medical emergency to a user's family, a doctor, an emergency call center and the like that have been predetermined by the user.

According to another embodiment of the present invention, the fall accident detection apparatus 10 may also be used to manually notify a medical emergency through an emergency button 151 when a user wants to notify a medical emergency other than the automatic fall accident detections. When the user presses the emergency button 151, an emergency signal is transmitted to the fall determination unit 134 through the input/output processing unit 135. Then, the fall determination unit 134 transmits the emergency signal to the fall control server 30 through the communication unit 160. In this case, the fall control server 30 manually transmits an emergency message to a family predetermined by the user, as described above.

However, when the emergency message is manually transmitted, the fall determination unit 134 can cancel a medical emergency in response to a signal generated by pressing an OK button. This procedure may be performed in the same manner as described above.

The fall accident detection apparatus 10 is provided with a communication unit including a wireless modem such as WCDMA, GSM and CDMA in order to communicate with the fall control server 30.

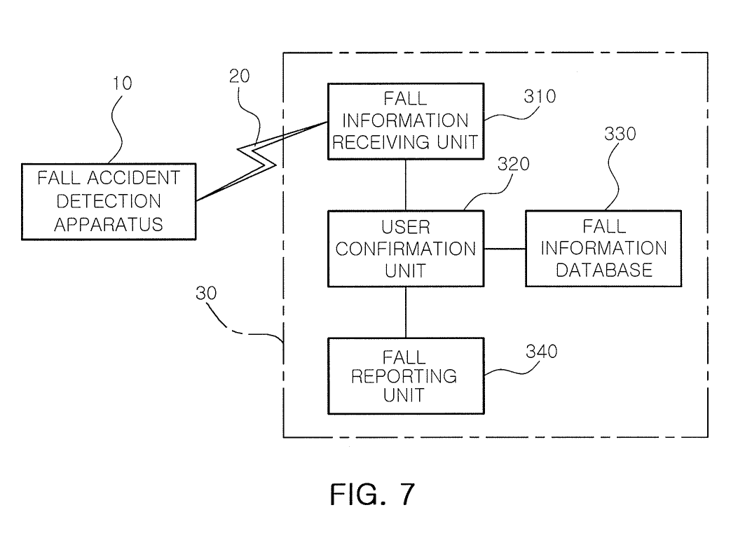

FIG. 7 is a diagram illustrating a configuration of a fall control server according to one exemplary embodiment of the present invention.

The fall control server 30 notifies a risk such as falls to a family, a doctor, an emergency call center and the like that have been predetermined by a user, depending on the fall accident signal transmitted from the fall accident detection apparatus 10.

The fall control server 30 includes a fall information receiving unit 310, a user confirmation unit 320, a fall information database 330 and a fall reporting unit 340.

The fall information receiving unit 310 receives information on a fall accident from the fall accident detection apparatus 10. The received information on the fall accident includes user's personal information, as well as information on a user's fall accident and a user's current location.

The user confirmation unit 320 uses the user's personal information to search the fall information database 330 and recognize a user's identity.

The user's personal information including user's personal numbers profiles, health, emergency contact numbers in the event of the fall and the like is stored in the fall information database 330.

The fall reporting unit 340 uses user's emergency contact numbers for the fall accident to notify the fall when the fallen-down user is identified by the user confirmation unit 320.

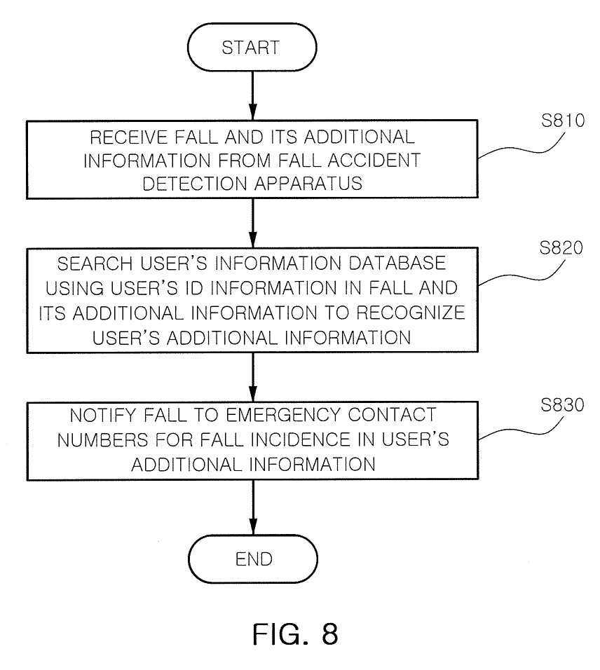

FIG. 8 is a flowchart illustrating an operation of the fall control server according to one exemplary embodiment of the present invention. The specific configuration of the fall control server 30 according to one exemplary embodiment of the present invention is described above, and therefore an operation of the fall control server 30 will be described in more detail.

First, the fall information receiving unit 310 receives the information on a fall accident and its additional information from the fall accident detection apparatus 10 (S810). Here, the information on a fall accident and its additional information include information on a user's fall accident, user's personal information. etc.

When the information on a fall accident is received from the fall accident detection apparatus 10, the user confirmation unit 320 uses the user's personal information in the received information on a fall accident to search the fall information database 330 in order to recognize a user's identity, and to simultaneously search for the user's emergency contact numbers in the event of the fall (S820).

Finally, the fall accident detection apparatus 10 notifies the fall to one of emergency contact numbers for the fall accident in the confirmed user's additional information (S830).

Meanwhile, the fall accident detection method according to one exemplary embodiment of the present invention as configured thus may be designed using a computer program. And codes and their segments constituting the computer program may be easily derived by computer programmers in the art. Also, the fall accident detection method according to one exemplary embodiment of the present invention may be achieved by storing the designed program in recorded media (information storage media) that are readable by a computer, and reading the stored designed program using a computer. Here, the recorded media include all types of recorded media that may be readable by a computer.

As described above, the fall accident detection apparatus and method according to one exemplary embodiment of the present invention may be useful to actively prepare for an unexpected emergency caused by falls by quickly detecting falls suffered by old, feeble or invalids and reporting on the falls.

Also, the fall accident detection apparatus and method according to one exemplary embodiment of the present invention may be useful to solve a variety of the problems that may be caused by the fall accident detection errors by employing the post-fall behaviors for the fall accident detection to precisely detect the fall.

Furthermore, the fall accident detection apparatus and method according to one exemplary embodiment of the present invention may be useful to reduce errors in fall accident detections and prepare for a medical emergency by allowing a user to cancel a medical emergency caused by the errors of fall accident detections, and manually report the medical emergency.

While the present invention has been shown and described in connection with the exemplary embodiments, it will be apparent to those skilled in the art that modifications and variations can be made without departing from the spirit and scope of the invention as defined by the appended claims.

What is claimed is:

1. A fall accident detection apparatus, comprising:
an acceleration sensor detecting information on acceleration and slope;
a controller judging behaviors using the information on acceleration and slope detected by the acceleration sensor and determining a fall accident by analyzing a sequential pattern of the judged behaviors; and
a communication unit transmitting information on a fall accident when the fall accident is determined by the controller.

2. The fall accident detection apparatus of claim 1, wherein the controller stores the information on acceleration and slope, which is detected by the acceleration sensor, into a data queue.

3. The fall accident detection apparatus of claim 2, wherein the controller takes some data from the data queue at predetermined intervals, judges behaviors using the data and stores the judged behaviors in a behavior queue.

4. The fall accident detection apparatus of claim 3, wherein the controller takes a certain number of behavior values out of the behavior queue at predetermined intervals and determines a fall accident by comparing the behavior values with a predetermined pattern of behavior queues.

5. The fall accident detection apparatus of claim 1, wherein the acceleration sensor comprises a 3-axis acceleration sensor.

6. The fall accident detection apparatus of claim 1, further comprising a GPS unit detecting information on current location, wherein the controller transmits the information on current location along with the information on the fall accident through the communication unit.

7. The fall accident detection apparatus of claim 6, further comprising:
an output unit outputting a fall confirmation signal when the fall accident is determined by the controller; and
a button unit inputting a signal indicating that there is no fall accident from a user.

8. The fall accident detection apparatus of claim 7, wherein the button unit further comprising function for inputting a signal indicating that the user is under a medical emergency.

9. A fall accident detection method, comprising:
detecting information on acceleration and slope;
judging behaviors using the detected information on acceleration and slope;
determining a fall accident by analyzing a sequential pattern of the judged behaviors; and
transmitting information on the fall accident based on the determination of the fall accident.

10. The fall accident detection method of claim 9, further comprising: detecting information on current location.

11. The fall accident detection method of claim 9, wherein the judging of the behaviors comprises:
storing the information on acceleration and slope into a data queue;
taking a certain number of data from the data queue at predetermined intervals;
judging behaviors using the taken data; and
storing the judged behaviors in a behavior queue.

12. The fall accident detection method of claim 11, wherein the determining of the fall accident comprise:
taking a certain number of behavior values out of the behavior queue at predetermined intervals; and
determining a fall accident by comparing the behavior values with a predetermined pattern of behavior queues.

13. The fall accident detection method of claim 12, further comprising: outputting an alarm signal activated by the determination of the fall accident.

14. The fall accident detection method of claim 13, further comprising: canceling the determination of the fall accident when a user presses a button in response to the alarm signal activated by the determination of the fall accident.
